(19) United States
(12) Patent Application Publication
(10) Pub. No.: US 2025/0115761 A1
(43) Pub. Date: Apr. 10, 2025

(54) LIGHT DIFFUSION MATERIAL APPLIED TO SECONDARY DIMMING OF LED LAMP AND PREPARATION METHOD THEREOF

(71) Applicant: General Lighting Electronic Co., Ltd., Zhongshan (CN)

(72) Inventor: Jiuhuai XIE, Loudi (CN)

(73) Assignee: General Lighting Electronic Co., Ltd., Zhongshan (CN)

(21) Appl. No.: 18/941,439

(22) Filed: Nov. 8, 2024

(30) Foreign Application Priority Data
Sep. 12, 2023 (CN) 202311169829X

(51) Int. Cl. C08L 83/04; C08K 3/22; C08K 3/36; F21V 9/40; F21Y 115/10

(52) U.S. Cl. CPC C08L 83/04; C08K 3/22; C08K 3/36; F21V 9/40; C08K 2003/2241; C08L 2203/20; C08L 2205/025; F21Y 2115/10

(57) ABSTRACT

The present application relates to a light diffusion material applied to secondary dimming of an LED lamp and a preparation method thereof. The light diffusion material for secondary dimming includes the following raw materials in percentage by weight: an A phase 94.09%, a B phase 2.91%, and a C phase 3%, where the A phase includes the following raw materials in percentage by weight: polydimethylmethylvinylsiloxane 55-95%, silicon dioxide 5-45%, hydroxyl-terminated polydimethylsiloxane 0-8%, and an additive 0-1%; the B phase includes the following raw materials in percentage by weight: silicon dioxide 70-80%, polydimethylsiloxane 10-20%, a 107 raw rubber 6-10%, and a dispersant 1.8-2.2%; and the C phase includes the following raw materials in percentage by weight: silicon dioxide 60-70%, polydimethylsiloxane 10-20%, a 107 raw rubber 6-10%, titanium dioxide 4-6%, a dispersant 5.88-7.78%, and a pigment 0.12-0.22%. By adding titanium dioxide to the light diffusion material of the lamp.

### CROSS-REFERENCE TO RELATED APPLICATIONS

The application claims priority to Chinese patent application No. 202311169829X, filed on Sep. 12, 2023, the entire contents of which are incorporated herein by reference.

### TECHNICAL FIELD

The present application relates to the technical field of compositions of high-molecular compounds, and in particular, to a light diffusion material applied to secondary dimming of an LED lamp and a preparation method thereof.

### BACKGROUND

The color temperature of an LED lamp refers to a color of the LED lamp when it emits light, and is a standard for measuring the color temperature. At present, a commonly used light diffusion material applied to secondary dimming of the LED lamp includes the following raw materials in percentage by weight:

| an A phase | 97%; and |
|---|---|
| a B phase | 3%; |

where
the A phase includes the following raw materials in percentage by weight:

| | |
|---|---|
| polydimethylmethylvinylsiloxane | 55-95%, |
| silicon dioxide | 5-45%, |
| hydroxyl-terminated polydimethylsiloxane | 0-8%, and |
| an additive | 0-1%; |

the B phase includes the following raw materials in percentage by weight:

| | |
|---|---|
| silicon dioxide | 70-80%, |
| polydimethylsiloxane | 10-20%, |
| a 107 raw rubber | 6-10%, and |
| a dispersant | 1.8-2.2%. |

When waterproofing the LED lamp, it is common to place the LED lamp in a silicone lamp strip made of a light diffusion material or drip glue onto a surface of the LED lamp to achieve a waterproofing function. During application, the following operations are performed: mixing a component a and a component b uniformly using a rubber mixing machine to obtain a material body, then adding 1% of a curing agent into the material body, continuing to perform uniform mixing, then performing co-extrusion molding with the LED lamp, then heating at 120-130° C. for 2-3 min, and then curing, where the curing agent includes the following raw materials in percentage by weight: silicon dioxide 20-30%, a platinum catalyst 10-20%, hydrosiloxane 50-55%, and an inhibitor 2-5%.

However, after the LED lamp is placed inside the silicone lamp strip through a co-extrusion process, the light emitted by the LED lamp penetrates through the silicone lamp strip to be diffused, causing a change in color temperature. This makes it difficult to accurately control a color temperature value of a product and a color of a finished LED lamp strip, failing to meet the accurate lighting color requirements of users.

### SUMMARY

The present invention aims to at least solve one of technical problems existing in the prior art. Therefore, the present invention proposes a light diffusion material applied to secondary dimming of an LED lamp and a preparation method thereof, adopting the following technical solution:

| | |
|---|---|
| A light diffusion material applied to secondary dimming of | 94.09%; |
| an LED lamp, including an A phase | |
| a B phase | 2.91%; and |
| a C phase | 3%, |

the A phase includes the following raw materials in percentage by weight:

| | |
|---|---|
| polydimethylmethylvinylsiloxane | 55-95%, |
| silicon dioxide | 5-45%, |
| hydroxyl-terminated polydimethylsiloxane | 0-8%, and |
| a dispersant | 0-1%; |

the B phase includes the following raw materials in percentage by weight:

| | |
|---|---|
| silicon dioxide | 70-80%, |
| polydimethylsiloxane | 10-20%, |
| a 107 raw rubber | 6-10%, and |
| a dispersant | 1.8-2.2%; |

the C phase includes the following raw materials in percentage by weight:

| | |
|---|---|
| silicon dioxide | 60-70%, |
| polydimethylsiloxane | 10-20%, |
| a 107 raw rubber | 6-10%, |
| titanium dioxide | 4-6%, |
| a dispersant | 5.88-7.78%, and |
| a pigment | 0.12-0.22%. |

In order to solve the technical problem, one embodiment of the present invention adopts a technical solution that the polydimethylmethylvinylsiloxane in the A phase has a molecular weight of 610,000 to 620,000.

In order to solve the technical problem, one embodiment of the present invention adopts a technical solution that the hydroxyl-terminated polydimethylsiloxane in the A phase has a viscosity of 950 Pa's to 1,050 Pa·s.

In order to solve the technical problem, one embodiment of the present invention adopts a technical solution that the dispersants in the A phase, the B phase and the C phase are all methyl silicone oil having a viscosity of 9,900 Pas to 10,100 Pa·s.

In order to solve the technical problem, one embodiment of the present invention adopts a technical solution that the silicon dioxide in the A phase, the B phase and the C phase has a particle size of less than or equal to 200 mesh, and the titanium dioxide in the C phase has a particle size of less than or equal to 200 mesh.

In order to solve the technical problem, one embodiment of the present invention adopts a technical solution that the polydimethylsiloxane in the B phase and the C phase has a molecular weight of 610,000 to 620,000.

In order to solve the technical problem, one embodiment of the present invention adopts a technical solution that the 107 raw rubber in the B phase and the C phase has a molecular weight of 580,000 to 670,000.

According to the present invention, a preparation method of the light diffusion material applied to secondary dimming of an LED lamp includes:
step 1, weighing A phase, B phase and C phase substances according to a formula, respectively, and using a refiner to make a particle size of silicon dioxide and titanium dioxide less than 200 mesh;
step 2, mixing raw materials of an A phase and a B phase uniformly using a rubber mixing machine to obtain a first material body; and
step 3, feeding the first material body and raw materials of a C phase to a mixer, and performing uniform mixing to obtain a light diffusion material for secondary dimming.

Beneficial effects of the present invention:

By using the light diffusion material as an LED waterproof material, the problem of color temperature drift of the LED lamp caused by the use of an existing waterproof material can be solved, the problem of serious color temperature drift of a finished LED lamp caused by waterproofing an existing LED lamp with the light diffusion material can be avoided, and the problem of serious color temperature drift of the LED lamp after waterproofing treatment can be solved, thus enabling the LED lamp to meet the color requirements of high-quality light.

The light diffusion material also performs secondary dimming on the light emitted by LED lamp beads, improves the phenomenon of color temperature drift caused by the light emitted by the LED lamp beads, and further makes the color temperature of the LED lamp more accurate, so as to achieve the color requirements of high-quality light.

### BRIEF DESCRIPTION OF THE DRAWINGS

The above and/or additional aspects and advantages of the present invention will become apparent and easy to understand from the description of the embodiments in conjunction with the following accompanying drawings, where:

FIG. 1 shows a color temperature detection graph of a light diffusion material in Embodiment 1 after being applied to a bare board of an LED light source with a color temperature of 1,800K;

FIG. 2 shows a color temperature detection graph of a light diffusion material in Embodiment 1 after being applied to a bare board of an LED light source with a color temperature of 5,000K;

FIG. 3 shows a color temperature detection graph of a light diffusion material in Embodiment 1 after being applied to a bare board of an LED light source with a color temperature of 12,000K;

FIG. 4 shows a color temperature detection graph of a bare board of an LED light source with a color temperature of 1,800K in Comparative Embodiment 1;

FIG. 5 shows a color temperature detection graph of a bare board of an LED light source with a color temperature of 5,000K in Comparative Embodiment 1;

FIG. 6 shows a color temperature detection graph of a bare board of an LED light source with a color temperature of 12,000K in Comparative Embodiment 1;

FIG. 7 shows a color temperature detection graph of a light diffusion material in Comparative Embodiment 2 after being applied to a bare board of an LED light source with a color temperature of 1,800K;

FIG. 8 shows a color temperature detection graph of a light diffusion material in Comparative Embodiment 2 after being applied to a bare board of an LED light source with a color temperature of 5,000K;

FIG. 9 shows a color temperature detection graph of a light diffusion material in Comparative Embodiment 2 after being applied to a bare board of an LED light source with a color temperature of 12,000K.

### DETAILED DESCRIPTION OF THE EMBODIMENTS

This part will describe the specific embodiments of the present invention in detail. The preferred embodiments of the present invention are shown in the accompanying drawings, and the function of the drawings is to supplement the description of the text part of the specification with graphics, which enables people to intuitively and vividly understand each technical feature and the overall technical solutions of the present invention, but cannot be understood as limiting the scope of protection of the present invention. In the description of the present invention, “a plurality of” means more than two, “greater than a number”, “less than a number”, “exceed a number” and the like indicate that the number is excluded, and “above a number”, “below a number”, “within a number”, and the like indicate that the number is included.

According to the present application, the light diffusion material for secondary dimming includes the following raw materials in percentage by weight:

| | |
|---|---|
| an A phase | 94.09%; |
| a B phase | 2.91%; and |
| a C phase | 3%, |

where
the A phase includes the following raw materials in percentage by weight:

| | |
|---|---|
| polydimethylmethylvinylsiloxane | 55-95%, |
| silicon dioxide | 5-45%, |
| hydroxyl-terminated polydimethylsiloxane | 0-8%, and |
| a dispersant | 0-1%; |

the B phase includes the following raw materials in percentage by weight:

| | |
|---|---|
| silicon dioxide | 70-80%, |
| polydimethylsiloxane | 10-20%, |
| a 107 raw rubber | 6-10%, and |
| a dispersant | 1.8-2.2%; |

the C phase includes the following raw materials in percentage by weight:

| | |
|---|---|
| silicon dioxide | 60-70%, |
| polydimethylsiloxane | 10-20%, |
| a 107 raw rubber | 6-10%, |
| titanium dioxide | 4-6%, |
| a dispersant | 5.88-7.78%, and |
| a pigment | 0.12-0.22%. |

According to the present application, methyl silicone oil was used as the dispersants in the A phase, the B phase and the C phase;
the silicon dioxide in the A phase, the B phase and the C phase was finely ground by a refiner to have a particle size of less than or equal to 200 mesh; and the pigment in the C phase was purchased from BASF under the designation Blue K 7090.

Embodiments of the present application are proposed based on the above description. Specific raw materials of the A phase, the B phase, and the C phase of the light diffusion material in Embodiments 1-3 and technical specifications thereof are shown in Tables 1-3.

TABLE 1

| | | CAS | | Embodiment | Embodiment | Embodiment |
|---|---|---|---|---|---|---|
| | Component | Number | Specification | 1 | 2 | 3 |
| A | Polydimethylmethylvinyl- | 68083-18-1 | Weight | 70% | 55% | 94% |
| phase | siloxane | | percentage | | | |
| | | | Molecular | 620,000 | 620,000 | 610,000 |
| | | | weight | | | |
| | Silicon dioxide | 112945-52-5 | Weight | 23% | 36% | 5% |
| | | | percentage | | | |
| | | | Particle | ≤200 mesh | ≤200 mesh | ≤200 mesh |
| | | | size | | | |
| | Hydroxyl-terminated | 70131-67-8 | Weight | 6% | 8% | 1% |
| | polydimethylsiloxane | | percentage | | | |
| | | | Viscosity | 1,000 | 950 | 1,050 |
| | | | (Pa · s) | | | |
| | Additive | 9006-65-9 | Weight | 1% | 1% | 0% |
| | | | percentage | | | |
| | | | Viscosity | 10,000 | 10,100 | — |
| | | | (Pa · s) | | | |

In Embodiments 1-3, polydimethylmethylvinylsiloxane in the A phase has a molecular weight of 610,000 to 620,000;
silicon dioxide has a particle size of less than or equal to 200 mesh;
hydroxyl-terminated polydimethylsiloxane has a viscosity of 950 Pas to 1,050 Pa's; and
methyl silicone oil has a viscosity of 10,000 Pa's to 10,100 Pa·s.

TABLE 2

| | | CAS | | Embodiment | Embodiment | Embodiment |
|---|---|---|---|---|---|---|
| | Component | Number | Specification | 1 | 2 | 3 |
| B | Silicon dioxide | 7631-86-9 | Weight | 75% | 78.20% | 70% |
| phase | | | percentage | | | |
| | | | Particle | ≤200 mesh | ≤200 mesh | ≤200 mesh |
| | | | size | | | |
| | Polydimethylsiloxane | 9016-00-6 | Weight | 15% | 10% | 20% |
| | | | percentage | | | |
| | | | Molecular | 620,000 | 610,000 | 620,000 |
| | | | weight | | | |
| | 107 raw rubber | 63148-60-7 | Weight | 8% | 10% | 7.80% |
| | | | percentage | | | |
| | | | Molecular | 580,000 | 650,000 | 670,000 |
| | | | weight | | | |
| | Dispersant | 9006-65-9 | Weight | 2% | 1.8% | 2.2% |
| | | | percentage | | | |
| | | | Viscosity | 10,000 | 10,100 | 9,900 |
| | | | (Pa · s) | | | |

In Embodiments 1-3, silicon dioxide in the B phase has a particle size of less than or equal to 200 mesh;
polydimethylsiloxane has a molecular weight of 610,000 to 620,000;
the 107 raw rubber has a molecular weight of 580,000 to 670,000; and
the methyl silicone oil dispersant has a viscosity of 9,900 Pa's to 10,100 Pa·s.

TABLE 3

| | | CAS | | Embodiment | Embodiment | Embodiment |
|---|---|---|---|---|---|---|
| | Component | Number | Specification | 1 | 2 | 3 |
| C | Silicon dioxide | 7631-86-9 | Weight | 65% | 60% | 70% |
| phase | | | percentage | | | |
| | | | Particle | ≤200 mesh | ≤200 mesh | ≤200 mesh |
| | | | size | | | |
| | Polydimethylsiloxane | 9016-00-6 | Weight | 15% | 20% | 10% |
| | | | percentage | | | |
| | | | Molecular | 620,000 | 610,000 | 620,000 |
| | | | weight | | | |
| | 107 raw rubber | 63148-60-7 | Weight | 8% | 10 | 6 |
| | | | percentage | | | |
| | | | Molecular | 580,000 | 650,000 | 670,000 |
| | | | weight | | | |
| | Titanium dioxide R- | 13463-67-7 | Weight | 5% | 4 | 6 |
| | TC30 | | percentage | | | |
| | | | Particle | ≤200 mesh | ≤200 mesh | ≤200 mesh |
| | | | size | | | |
| | Pigment BSF-7090 | 147-14-8 | Weight | 0.17% | 0.12 | 0.22 |
| | | | percentage | | | |
| | | | — | — | — | — |
| | Dispersant | 9006-65-9 | Weight | 6.83% | 5.88 | 7.78 |
| | | | percentage | | | |
| | | | Viscosity | 10,000 | 10,100 | 9,900 |
| | | | (Pa · s) | | | |

In Embodiments 1-3,
both silicon dioxide and titanium dioxide in the C phase have particle sizes of less than or equal to 200 mesh;
polydimethylsiloxane has a molecular weight of 610,000 to 620,000;
the 107 raw rubber has a molecular weight of 580,000 to 670,000;
a designation of titanium dioxide is Huntsman RTC30;
the methyl silicone oil dispersant has a viscosity of 9,900 Pa's to 10,100 Pa's; and
a designation of the pigment is BASF Blue K 7090.

After completing the formulation of the raw materials in Embodiments 1-3, a preparation method of the light diffusion material in Embodiments 1-3 included:
step 1, weighing A phase, B phase and C phase substances according to a formula, respectively, and using a refiner to make a particle size of silicon dioxide and titanium dioxide less than 200 mesh;
step 2, mixing raw materials of an A phase and a B phase uniformly using a rubber mixing machine to obtain a first material body; and
step 3, feeding the first material body and raw materials of a C phase to a mixer, and performing uniform mixing to obtain a light diffusion material for secondary dimming.

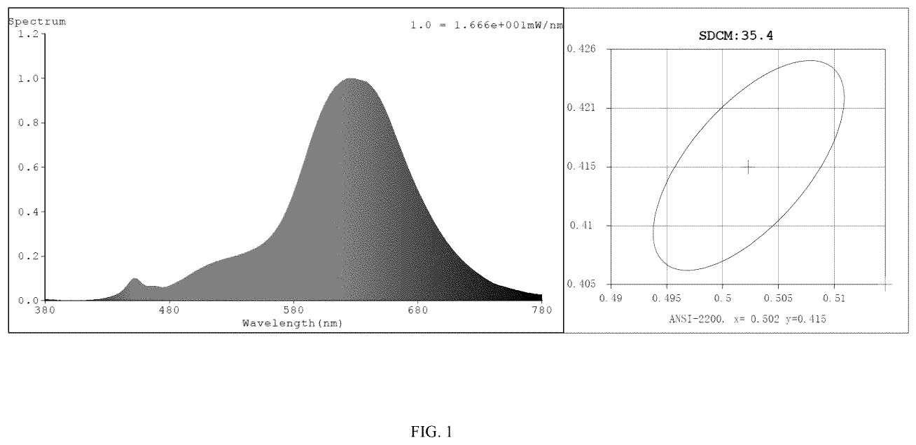

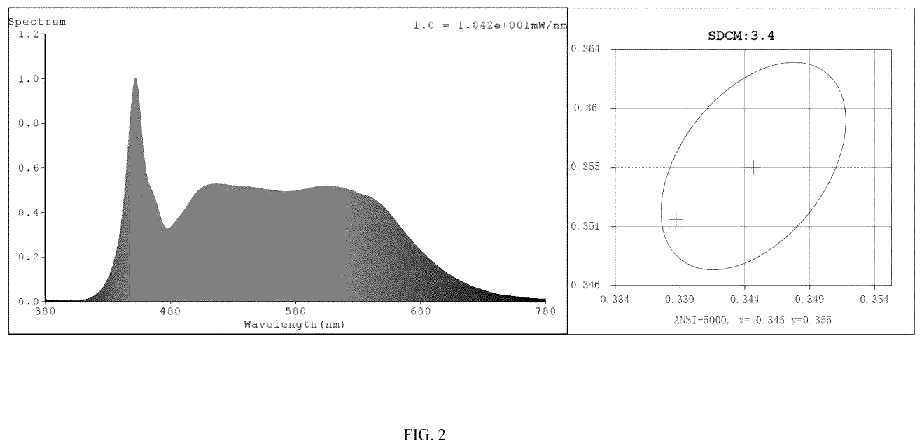

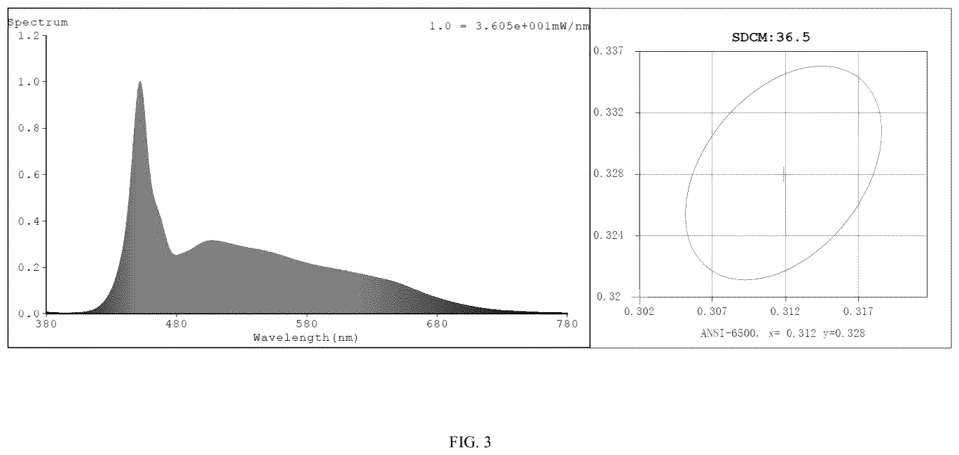

The specific operation included: adding a curing agent with a weight ratio of 1% to the light diffusion material obtained in Embodiment 1, performing uniform mixing, and then performing co-extrusion with bare boards of an LED light source with color temperatures of 1,800K, 5,000K, and 12,000K, respectively, heating at 120-130° C. for 2-3 min, and then curing. Spectrums of light penetrating through the light diffusion material in Embodiment 1 were tested, and test reports were shown in FIGS. 1-3, respectively.

### Comparative Embodiment 1

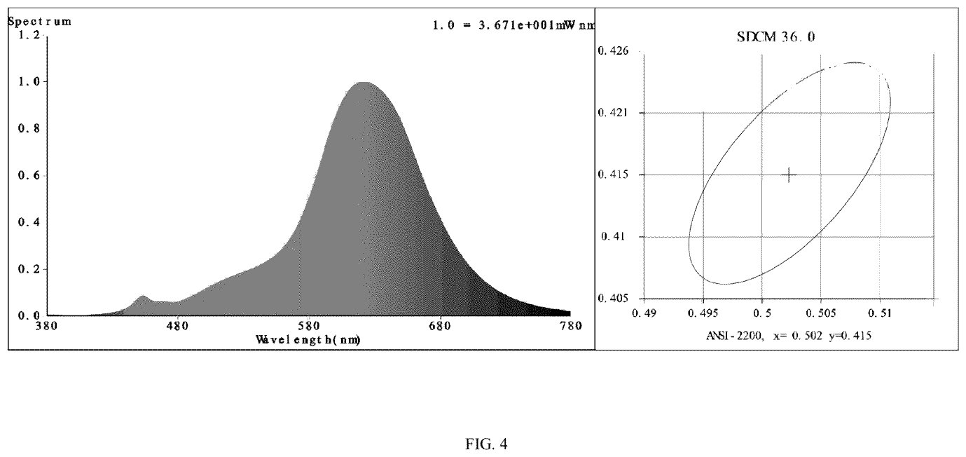

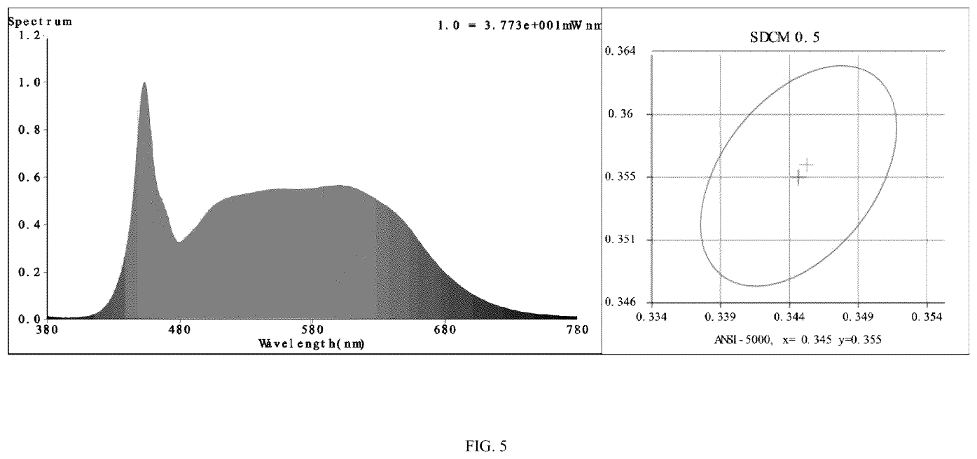

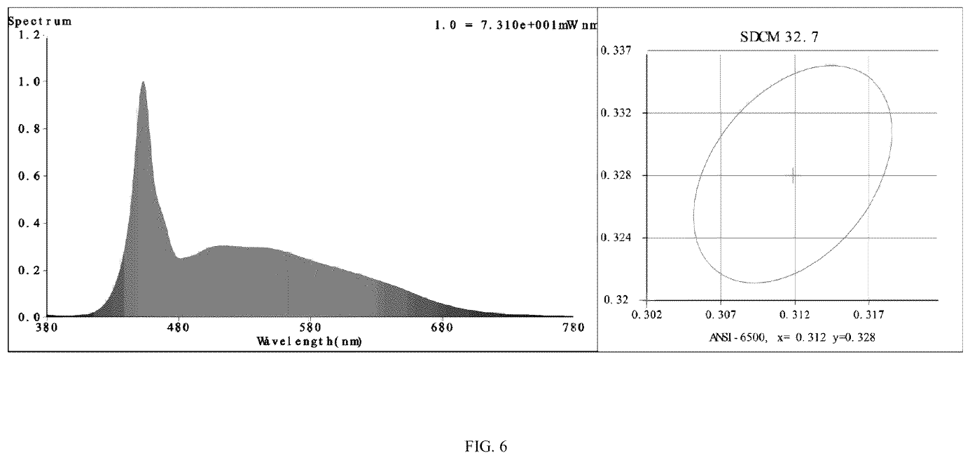

Spectrums of bare boards of an LED light source with color temperatures of 1,800K, 5,000K, and 12,000K were tested, and test reports were shown in FIGS. 4-6.

### Comparative Embodiment 2

The light diffusion material in Comparative Embodiment 2 included the following raw materials in percentage by weight:

| | |
|---|---|
| an A phase | 97%; |
| a B phase | 3%; |

where

| | |
|---|---|
| polydimethylmethylvinylsiloxane | 55-95%, |
| silicon dioxide | 5-45%, |
| hydroxyl-terminated polydimethylsiloxane | 0-8%, and |
| an additive | 0-1%; |

the B phase included the following raw materials in percentage by weight:

| | |
|---|---|
| silicon dioxide | 70-80%, |
| polydimethylsiloxane | 10-20%, |
| a 107 raw rubber | 6-10%, and |
| a dispersant | 1.8-2.2%. |

Specific raw materials of the A phase and the B phase in Comparative Embodiment 2 and percentage contents thereof were shown in Table 5.

TABLE 5

| | | | | Comparative |
|---|---|---|---|---|
| | | CAS | | Embodiment |
| | Component | Number | Specification | 2 |
| A | Polydimethylmethylvinylsiloxane | 68083-18- | Weight | 70% |
| phase | | 1 | percentage | |
| | | | Molecular | 620,000 |
| | | | weight | |
| | Silicon dioxide | 112945- | Weight | 23% |
| | | 52-5 | percentage | |
| | | | Particle size | ≤200 mesh |
| | Hydroxyl-terminated | 70131-67- | Weight | 6% |
| | polydimethylsiloxane | 8 | percentage | |
| | | | Viscosity | 1,000 |
| | | | (Pa · s) | |
| | Additive | 9006-65-9 | Weight | 1% |
| | | | percentage | |
| | | | Viscosity | 10,000 |
| | | | (Pa · s) | |
| b | Silicon dioxide | 7631-86-9 | Weight | 75% |
| phase | | | percentage | |
| | | | Particle size | ≤200 mesh |
| | Polydimethylsiloxane | 9016-00-6 | Weight | 15% |
| | | | percentage | |
| | | | Molecular | 620,000 |
| | | | weight | |
| | 107 raw rubber | 63148-60- | Weight | 8% |
| | | 7 | percentage | |
| | | | Molecular | 580,000 |
| | | | weight | |
| | Dispersant | 9006-65-9 | Weight | 0.02 |
| | | | percentage | |
| | | | Viscosity | 10,000 |
| | | | (Pa · s) | |

A preparation method of the light diffusion material in Comparative Embodiment 2 included:
step 1, weighing raw materials of the A phase and the B phase according to a formula, respectively, and using a refiner to make a particle size of silicon dioxide less than 200 mesh; and
step 2, mixing the raw materials of the A phase and the B phase uniformly using a rubber mixing machine to obtain a light diffusion material.

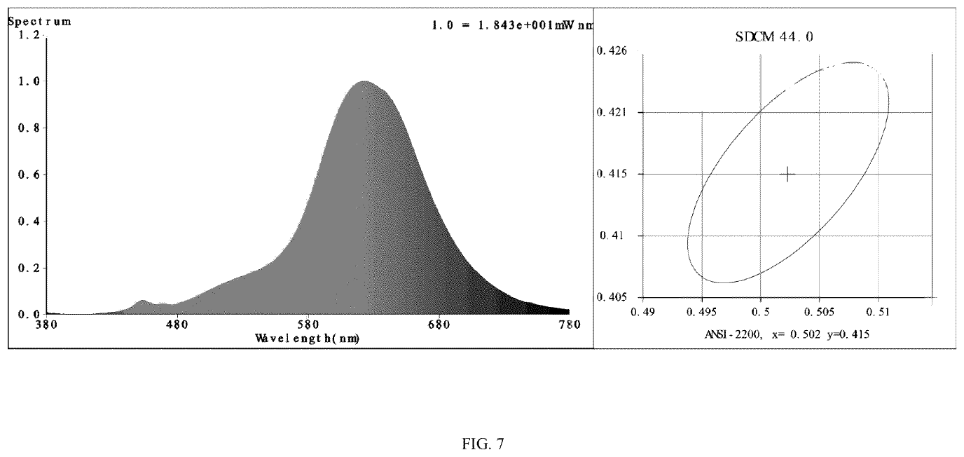

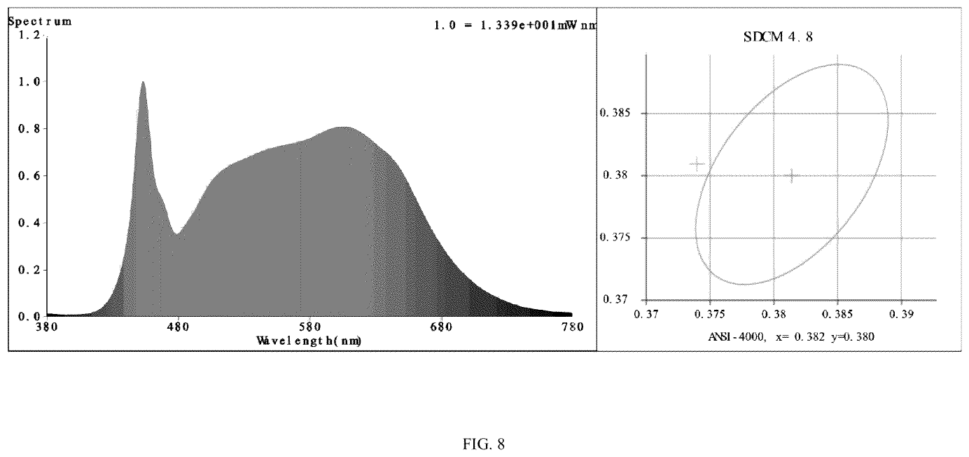

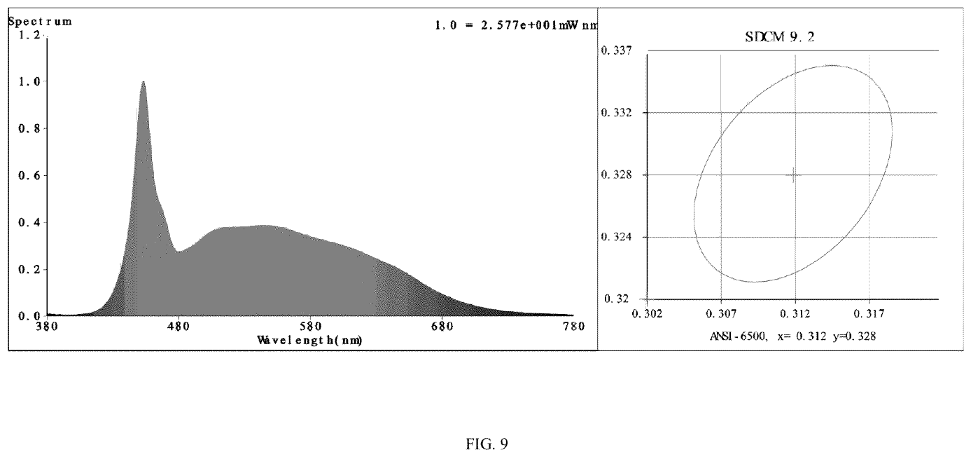

The specific operation included: adding a curing agent with a weight ratio of 1% to the light diffusion material obtained in Comparative Embodiment 2, performing uniform mixing, and then performing co-extrusion with bare boards of an LED light source with color temperatures of 1,800K, 5,000K, and 12,000K, respectively, heating at 120-130° C. for 2-3 min, and then curing. Spectrums of light penetrating through the light diffusion material in Comparative Embodiment 2 were tested, and test reports were shown in FIGS. 7-9, respectively.

Specific raw materials of each component of the curing agents in Embodiment 1 and Comparative Embodiment 2 and technical specifications thereof were shown in Table 4.

TABLE 4

| | | | | Embodiments |
|---|---|---|---|---|
| | Component | CAS Number | Specification | 1-3 |
| Curing | Silicon | 14808-60-7 | Weight | 25% |
| agent | dioxide | | percentage | |
| | | | Particle size | ≤200 mesh |
| | Platinum | 7440-6-4 | Weight | 15% |
| | catalyst | | percentage | |
| | Hydrosiloxane | 63148-60-7 | Weight | 52% |
| | | | percentage | |
| | | | Molecular | 580,000 |
| | | | weight | |
| | Inhibitor | 78-27-3 | Weight | 5% |
| | | | percentage | |

It can be seen from the content of FIGS. 1-9 that:
(1) the detection results shown in FIGS. 4-6 indicated that the color temperatures of the bare boards of the LED light source with 1,800K, 5,000K, and 12,000K obtained through testing were 1,760K, 5,006K, and 11,968K, respectively, meaning that all color temperatures of the bare boards of the LED light source had color drift;
(2) the detection results shown in FIGS. 7-9 indicated that after the light diffusion material obtained in Comparative Embodiment 2 was applied to the bare boards of the LED light source with 1,800K, 5,000K, and 12,000K, the color temperatures finally obtained were 1,679K, 4,193K, and 7,472K, respectively. Compared to Comparative Embodiment 1, the light diffusion material adopted in Comparative Embodiment 2 leaded to a larger drift in the color temperatures of the bare boards of the LED light source;
(3) the detection results shown in FIGS. 1-3 indicated that after the light diffusion material obtained in Embodiment 1 was applied to the bare boards of the LED light source with 1,800K, 5,000K, and 12,000K, the color temperatures finally obtained were 1,766K, 5,043K, and 12,282K, respectively.

Compared with Comparative Embodiment 2, Embodiment 1 had basically no change in color temperatures, and the color temperatures of the LED lamp were accurate. Therefore, according to this embodiment, the influence of existing light diffusion materials on the color temperature of an LED can be solved, the problem of color drift caused by waterproofing the LED can be solved, the problem that the color of a finished LED lamp strip cannot be accurately controlled due to inaccurate control of the color temperature of the LED light source can be solved, and the phenomenon of color temperature drift of the LED lamp itself can also be improved.

Certainly, the present invention is not limited to the above-mentioned implementation. Those skilled in the art may also make equivalent modifications or replacements without violating the spirit of the present invention. These equivalent modifications and replacements all fall within the scope of the claims of the present application.

What is claimed is:

1. A light diffusion material applied to secondary dimming of an LED lamp, comprising the following raw materials in percentage by weight:

| | |
|---|---|
| an A phase | 94.09%; |
| a B phase | 2.91%; and |
| a C phase | 3%, |

wherein
the A phase comprises the following raw materials in percentage by weight:

| | |
|---|---|
| polydimethylmethylvinylsiloxane | 55-95%, |
| silicon dioxide | 5-45%, |
| hydroxyl-terminated polydimethylsiloxane | 0-8%, and |
| a dispersant | 0-1%; |

the B phase comprises the following raw materials in percentage by weight:

| | |
|---|---|
| silicon dioxide | 70-80%, |
| polydimethylsiloxane | 10-20%, |
| a 107 raw rubber | 6-10%, and |
| a dispersant | 1.8-2.2%; |

the C phase comprises the following raw materials in percentage by weight:

| | |
|---|---|
| silicon dioxide | 60-70%, |
| polydimethylsiloxane | 10-20%, |
| a 107 raw rubber | 6-10%, |
| titanium dioxide | 4-6%, |
| a dispersant | 5.88-7.78%, and |
| a pigment | 0.12-0.22%. |

2. The light diffusion material applied to secondary dimming of an LED lamp according to claim 1, wherein the polydimethylmethylvinylsiloxane in the A phase has a molecular weight of 610,000 to 620,000.

3. The light diffusion material applied to secondary dimming of an LED lamp according to claim 1, wherein the hydroxyl-terminated polydimethylsiloxane in the A phase has a viscosity of 950 Pas to 1,050 Pa·s.

4. The light diffusion material applied to secondary dimming of an LED lamp according to claim 1, wherein the dispersants in the A phase, the B phase and the C phase are all methyl silicone oil having a viscosity of 9,900 Pa's to 10,100 Pa·s.

5. The light diffusion material applied to secondary dimming of an LED lamp according to claim 1, wherein the silicon dioxide in the A phase, the B phase and the C phase has a particle size of less than or equal to 200 mesh, and the titanium dioxide in the C phase has a particle size of less than or equal to 200 mesh.

6. The light diffusion material applied to secondary dimming of an LED lamp according to claim 1, wherein the polydimethylsiloxane in the B phase and the C phase has a molecular weight of 610,000 to 620,000.

7. The light diffusion material applied to secondary dimming of an LED lamp according to claim 1, wherein the 107 raw rubber in the B phase and the C phase has a molecular weight of 580,000 to 670,000.

8. A preparation method of the light diffusion material applied to secondary dimming of an LED lamp according to claim 1, wherein the method comprises:
step 1, weighing A phase, B phase and C phase substances according to a formula, respectively, and using a refiner to make a particle size of silicon dioxide and titanium dioxide less than 200 mesh;
step 2, mixing raw materials of an A phase and a B phase uniformly using a rubber mixing machine to obtain a first material body; and
step 3, feeding the first material body and raw materials of a C phase to a mixer, and performing uniform mixing to obtain a light diffusion material for secondary dimming.
